(19) United States
(12) Patent Application Publication
(10) Pub. No.: US 2024/0209890 A1
(43) Pub. Date: Jun. 27, 2024

(54) FOIL BEARING

(71) Applicant: KABUSHIKI KAISHA TOYOTA JIDOSHOKKI, Aichi (JP)

(72) Inventors: Fumiya SHINODA, Aichi (JP); Fumihiro SUZUKI, Aichi (JP)

(73) Assignee: KABUSHIKI KAISHA TOYOTA JIDOSHOKKI, Aichi (JP)

(21) Appl. No.: 18/543,688

(22) Filed: Dec. 18, 2023

(30) Foreign Application Priority Data
Dec. 26, 2022 (JP) 2022-208783

(51) Int. Cl. F16C 17/02; F16C 37/00

(52) U.S. Cl. CPC F16C 17/024; F16C 37/002

(57) ABSTRACT

A foil bearing includes a thin plate member disposed between bump foils and a bearing housing. The bearing housing has a regulation groove into which a part of a top foil and a part of the thin plate member are inserted and which regulates movement of the top foil and the thin plate member in a circumferential direction of a rotary shaft. A regulator is disposed on the regulation groove and regulates the movement of the top foil and the thin plate member in an axial direction of the rotary shaft. The thin plate member has an opening that is opened on an inner peripheral surface of the thin plate member. A part of the bump foils is inserted into and engaged with the opening so that movement of the bump foils is regulated in the circumferential direction and the axial direction relative to the bearing housing.

### CROSS-REFERENCE TO RELATED APPLICATION

This application claims priority to Japanese Patent Application No. 2022-208783 filed on Dec. 26, 2022, the entire disclosure of which is incorporated herein by reference.

The present disclosure relates to a foil bearing.

### BACKGROUND ART

Japanese Patent Application Publication No. 2003-021137 mentions a foil bearing that includes a bearing housing having a cylindrical shape, a top foil, a plurality of bump foils, and a thin plate member. A rotary shaft is inserted through the bearing housing. The top foil is disposed between the rotary shaft and the bearing housing. The top foil has a bearing surface that faces the rotary shaft and extends in the circumferential direction of the rotary shaft. The bump foils are disposed outward of the top foil. The bump foils are configured to extend to elastically support the top foil. The thin plate member is disposed between the bearing housing and the bump foils. The thin plate member extends in the circumferential direction of the rotary shaft. The bearing housing has a regulation groove in which a part of the top foil and a part of the thin plate member are inserted. Inserting a part of the top foil and a part of the thin plate member into the regulation groove regulates the movement of the top foil and the thin plate member in the circumferential direction of the rotary shaft.

Such a foil bearing having a plurality of bump foils needs to regulate the movement of the bump foils in the axial direction of the rotary shaft relative to the bearing housing so as to prevent the bump foils from falling out of the bearing housing.

For example, the foil bearing is provided with a plurality of regulators, and the regulators are arranged in the circumferential direction of the rotary shaft to individually regulate the movement of the bump foils. However, the provision of multiple regulators increases the number of parts of the foil bearing.

For example, a ring shaped regulator, such as a circlip, may regulate the movement of the multiple bump foils collectively. This prevents an increase in the number of parts of the foil bearing. However, such a ring-shaped regulator needs to be fitted in a groove formed in the bearing housing, thereby increasing the size of the bearing housing in the radial direction of the rotary shaft.

The present disclosure, which has been made in light of the above-mentioned circumstance, is directed to providing a foil bearing that is capable of preventing a bump foil from falling out of a bearing housing without increasing the number of parts of the foil bearing and increasing the size of the bearing housing.

### SUMMARY

In accordance with an aspect of the present disclosure, there is provided a foil bearing that includes: a bearing housing; a top foil; a plurality of bump foils; and a thin plate member. The bearing housing has a cylindrical shape, and a rotary shaft is inserted through the bearing housing. The top foil is disposed between the rotary shaft and the bearing housing, and has a bearing surface that faces the rotary shaft and extends in a circumferential direction of the rotary shaft. The plurality of bump foils is disposed outward of the top foil and configured to extend to elastically support the top foil. The thin plate member is disposed between the bump foils and the bearing housing and extends in the circumferential direction. The bearing housing has a regulation groove into which a part of the top foil and a part of the thin plate member are inserted, and the regulation groove regulates movement of the top foil and the thin plate member in the circumferential direction. The foil bearing includes a regulator that is disposed on the regulation groove and regulates the movement of the top foil and the thin plate member in an axial direction of the rotary shaft. The thin plate member has an opening that is opened on an inner peripheral surface of the thin plate member. A part of the bump foils is inserted into and engaged with the opening so that movement of the bump foils is regulated in the circumferential direction and the axial direction relative to the bearing housing.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a sectional view of a centrifugal compressor;

FIG. 2 is an exploded perspective view of a foil bearing according to a first embodiment;

FIG. 3 is a sectional view of the foil bearing according to the first embodiment;

FIG. 4 is a developed view of a thin plate member according to the first embodiment;

FIG. 5 is a sectional view of the foil bearing according to the first embodiment, taken along line V-V in FIG. 3;

FIG. 6 is a sectional view of the foil bearing according to the first embodiment, taken along line VI-VI in FIG. 3;

FIG. 7 is a developed view of a thin plate member according to a second embodiment;

FIG. 8 is a sectional view of a foil bearing according to the second embodiment;

FIG. 9 is a sectional view of the foil bearing according to the second embodiment, taken along line IX-IX in FIG. 8;

FIG. 10 is a partial perspective view of a thin plate member according to a modification example;

FIG. 11 is a fragmentary sectional view of a foil bearing according to the modification example;

FIG. 12 is a developed view of the thin plate member according to the modification example;

FIG. 13 is a sectional view of the foil bearing according to the modification example; and

FIG. 14 is a developed view of the thin plate member according to the modification example.

### DETAILED DESCRIPTION OF THE EMBODIMENTS

### First Embodiment

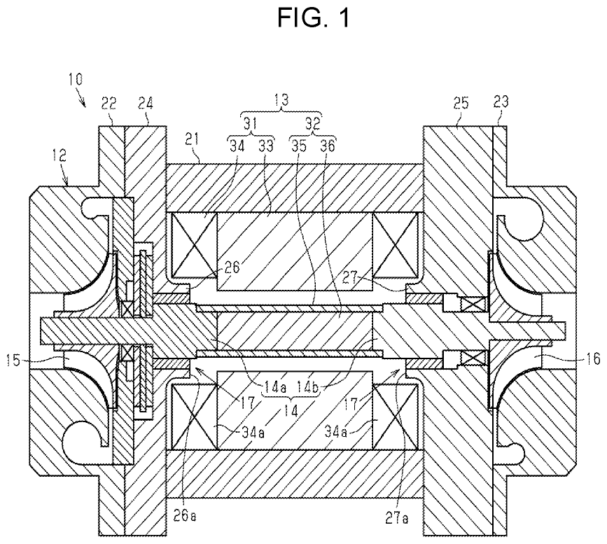

The following will describe a first embodiment of a foil bearing with reference to accompanying FIGS. 1 to 6. The foil bearing according to the first embodiment is applied to a centrifugal compressor.

### <Configuration of Centrifugal Compressor>

As illustrated in FIG. 1, a centrifugal compressor 10 includes a housing 12, a motor 13, a rotary shaft 14, an impeller 15, a turbine wheel 16, and a plurality of foil bearings 17 (two foil bearings 17, in this embodiment).

The housing 12 accommodates the motor 13, the rotary shaft 14, the impeller 15, and the turbine wheel 16. The housing 12 is made of metal. According to this embodiment, the housing 12 is made of aluminum.

According to this embodiment, the housing 12 includes a motor housing 21 having a cylindrical shape, a compressor housing 22 having a cylindrical shape, a turbine housing 23 having a cylindrical shape, a first plate 24 having a circular ring shape, and a second plate 25 having a circular ring shape. The motor housing 21 is disposed between the compressor housing 22 and the turbine housing 23. The first plate 24 is disposed between the motor housing 21 and the compressor housing 22. The first plate 24 has a first boss 26 that has a cylindrical shape and projects from the inner peripheral edge of the first plate 24 toward the motor housing 21. The second plate 25 is disposed between the motor housing 21 and the turbine housing 23. The second plate has a second boss 27 that has a cylindrical shape and projects from the inner peripheral edge of the second plate 25 toward the motor housing 21.

The motor 13 is accommodated in the motor housing 21. The motor 13 includes a stator 31 and a rotor 32.

The stator 31 includes a stator core 33 and a coil 34. The stator core 33 has a cylindrical shape. The outer peripheral surface of the stator core 33 is fixed to the inner peripheral surface of the motor housing 21. The coil 34 is wound around the stator core 33. The coil 34 has a pair of coil ends 34a that respectively project from the opposite end surfaces of the stator core 33 in the axial direction of the stator core 33. According to this embodiment, one and the other coil ends 34a surround the first boss 26 and the second boss 27, respectively. In other words, the first boss 26 and the second boss 27 are disposed inside the coil ends 34a.

The rotor 32 is disposed inside the stator 31. According to this embodiment, the rotor 32 includes a cylindrical member 35, and a permanent magnet 36 as a magnetic material. The cylindrical member 35 has a circular cylindrical shape. The cylindrical member 35 is, for example, made of titanium alloy. The permanent magnet 36 has a solid cylindrical shape. The length of the permanent magnet 36 in the axial direction of the permanent magnet 36 is shorter than that of the cylindrical member 35 in the axial direction of the cylindrical member 35. The permanent magnet 36 is disposed inside the cylindrical member 35. The axial direction of the permanent magnet 36 corresponds to the axial direction of the cylindrical member 35. The cylindrical member 35 projects from the opposite end surfaces of the permanent magnet 36 in the axial direction of the permanent magnet 36. The coil 34 is supplied with current, which causes a rotating magnetic field in the stator 31, thereby rotating the rotor 32.

The rotary shaft 14 has a first shaft member 14a and a second shaft member 14b. The first shaft member 14a and the second shaft member 14b are made of iron, for example. The first shaft member 14a and the second shaft member 14b are inserted into one end and the other end of the cylindrical member 35 in the axial direction of the cylindrical member 35. The permanent magnet 36 is disposed between the first shaft member 14a and the second shaft member 14b in the axial direction of the cylindrical member 35. The rotary shaft 14 is fixed to the rotor 32. The rotary shaft 14 rotates together with the rotor 32.

The first shaft member 14a is inserted into the first boss 26 and penetrates the first plate 24. The first shaft member 14a protrudes inside the compressor housing 22. The impeller 15 is connected to the first shaft member 14a in the compressor housing 22. The impeller 15 is accommodated in the compressor housing 22. The rotation of the rotary shaft 14 rotates the impeller 15 integrally. The rotation of the impeller 15 draws air into the compressor housing 22 from the outside of the housing 12. The air drawn into the compressor housing 22 is compressed with the rotation of the impeller 15. The compressed air is supplied to a fuel cell stack (not illustrated), for example.

The second shaft member 14b is inserted into the second boss 27 and penetrates the second plate 25. The second shaft member 14b protrudes inside the turbine housing 23. The turbine wheel 16 is connected to the second shaft member 14b in the turbine housing 23. The turbine wheel 16 is accommodated in the turbine housing 23. The rotation of the rotary shaft 14 rotates the turbine wheel 16 integrally. The exhaust from the fuel cell stack is introduced into the turbine housing 23. The exhaust introduced into the turbine housing 23 rotates the turbine wheel 16.

The two foil bearings 17 support the rotary shaft 14 in a radial direction. The radial direction is a direction perpendicular to the axial direction of the rotary shaft 14. One and the other of the foil bearings 17 support the first shaft member 14a and the second shaft member 14b, respectively, such that the first shaft member 14a and the second shaft member 14b are rotatable.

According to this embodiment, the first boss 26 forms a part of the foil bearing 17 supporting the first shaft member 14a. The second boss 27 forms a part of the foil bearing 17 supporting the second shaft member 14b. The first boss 26 and the second boss 27 are disposed inside the coil ends 34a as previously described. Accordingly, the foil bearings 17 are disposed inside the coil ends 34a.

### <Foil Bearing>

The following will describe the foil bearings 17.

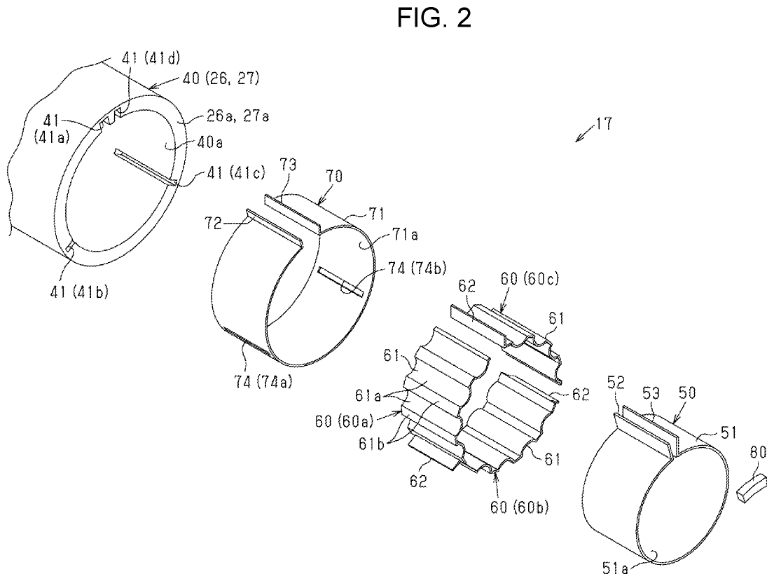

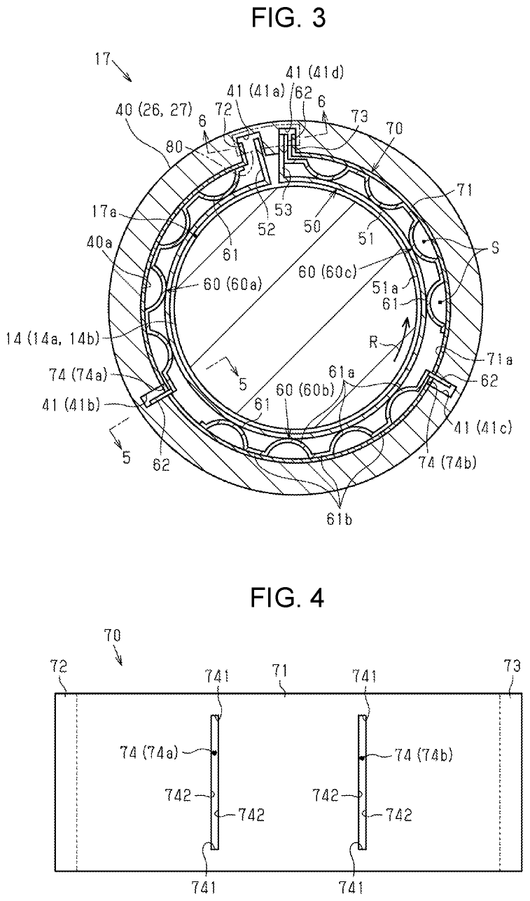

As illustrated in FIGS. 2 and 3, each foil bearing 17 includes a bearing housing 40 having a cylindrical shape, a top foil 50, a plurality of bump foils 60, a thin plate member 70, and a regulator 80. According to this embodiment, specifically, the foil bearing 17 has three bump foils 60.

The bearing housing 40 has an inner peripheral surface 40a that has a cylindrical surface. The rotary shaft 14 is inserted through the bearing housing 40. The axial direction of the bearing housing 40 corresponds to the axial direction of the rotary shaft 14. According to this embodiment, each of the first boss 26 and the second boss 27 serves as the bearing housing 40. Accordingly, the bearing housing 40 of this embodiment is made of aluminum.

The bearing housing 40 has a plurality of grooves (four grooves 41, in this embodiment). The grooves 41 are formed in an inner peripheral surface 40a of the bearing housing 40. The four grooves 41 are spaced from each other in the circumferential direction of the bearing housing 40. The grooves 41 extend in the axial direction of the bearing housing 40. According to this embodiment, the boss 26 and the boss 27 have an end surface 26a and an end surface 27a, respectively. The end surfaces 26a, 27a each serve as one end surface of the bearing housing 40 in the axial direction of the bearing housing 40, and the grooves 41 are opened on the end surfaces 26a, 27a.

The grooves 41 include a first groove 41a, a second groove 41b, a third groove 41c, and a fourth groove 41d. The first groove 41a, the second groove 41b, the third groove 41c, and the fourth groove 41d are arranged in this order in the circumferential direction of the bearing housing 40. The width of the first groove 41a is larger than those of the second groove 41b, the third groove 41c, and the fourth groove 41d in the circumferential direction of the bearing housing 40. The distance between the first groove 41a and the second groove 41b, the distance between the second groove 41b and the third groove 41c, and the distance between the third groove 41c and the fourth groove 41d are longer than the distance between the fourth groove 41d and the first groove 41a in the circumferential direction of the bearing housing 40.

The top foil 50 has a foil cylindrical portion 51, a free end 52, and a fixed end 53. The foil cylindrical portion 51 has an incomplete cylindrical shape that has a circumferential cutout. The foil cylindrical portion 51 has a first end and a second end in the circumferential direction of the foil cylindrical portion 51. The free end 52 protrudes radially outward from the first end of the foil cylindrical portion 51. The fixed end 53 protrudes radially outward from the second end of the foil cylindrical portion 51. The free end 52 and the fixed end 53 are a part of the top foil 50.

The top foil 50 is formed of a flexible long metallic plate by curving the long metallic plate. The metallic plate forming the top foil 50 is a plate of stainless steel, such as SUS301 or SUS304. The foil cylindrical portion 51 is formed by curving a part of the long metallic plate into a cylindrical shape. According to this embodiment, the longer direction of the metallic plate forming the top foil 50 corresponds to the circumferential direction of the foil cylindrical portion 51. The shorter direction of the metallic plate forming the top foil 50 corresponds to the axial direction of the foil cylindrical portion 51. The metallic plate has opposite ends in the longer direction, and the free end 52 and the fixed end 53 are formed by bending the opposite ends of the metallic plate in the radially outward direction of the foil cylindrical portion 51.

As illustrated in FIG. 3, the top foil 50 is disposed between the rotary shaft 14 and the bearing housing 40. The axial direction of the foil cylindrical portion 51 corresponds to the axial direction of the rotary shaft 14. The inner peripheral surface 51a of the foil cylindrical portion 51 faces the outer peripheral surface of the rotary shaft 14. The inner peripheral surface 51a of the foil cylindrical portion 51 serves as the bearing surface of the present disclosure that faces the rotary shaft 14 and extends in the circumferential direction of the rotary shaft 14. The free end 52 and the fixed end 53 protrude toward the bearing housing 40 from the circumferentially opposite ends of the foil cylindrical portion 51. The free end 52 is inserted into the first groove 41a. The fixed end 53 is inserted into the fourth groove 41d. This regulates the movement of the top foil 50 in the circumferential direction of the rotary shaft 14 relative to the bearing housing 40.

The three bump foils 60 are disposed outward of the top foil 50. The bump foils 60 are configured to extend to elastically support the top foil 50. The bump foils 60 are spaced from each other in the circumferential direction of the rotary shaft 14. The bump foils 60 include a first bump foil 60a, a second bump foil 60b, and a third bump foil 60c.

As illustrated in FIGS. 2 and 3, each of the bump foils 60 has a main body 61 and a stopper 62.

The main body 61 has a corrugated shape. The main body 61 has a plurality of projections 61a and a plurality of depressions 61b. The projections 61a and the depressions 61b are alternately arranged in the circumferential direction of the rotary shaft 14. The projections 61a are in contact with the outer peripheral surface of the foil cylindrical portion 51 of the top foil 50. The projections 61a become deformed elastically so as to extend in the circumferential direction of the rotary shaft 14, so that the main body 61 elastically supports the top foil 50. The depressions 61b are in contact with an inner peripheral surface 71a of the thin plate member 70.

The stopper 62 protrudes toward the bearing housing 40 from one end of the main body 61 in the circumferential direction of the rotary shaft 14. Specifically, each main body 61 has opposite ends in the circumferential direction of the rotary shaft 14, and the stopper 62 of the first bump foil 60a protrudes toward the bearing housing 40 from one of the opposite ends of the main body 61 adjacent to the second bump foil 60b. The stopper 62 of the second bump foil 60b protrudes toward the bearing housing 40 from one of the opposite ends of the main body 61 adjacent to the third bump foil 60c. The stopper 62 of the third bump foil 60c protrudes toward the bearing housing 40 from one of the opposite ends of the main body 61 adjacent to the first bump foil 60a.

The length of the stopper 62 of the first bump foil 60a is shorter than the length of the main body 61 in the axial direction of the rotary shaft 14. The length of the stopper 62 of the second bump foil 60b is shorter than the length of the main body 61 in the axial direction of the rotary shaft 14. The length of the stopper 62 of the third bump foil 60c is equal to the length of the main body 61 in the axial direction of the rotary shaft 14.

Each bump foil 60 is formed of a flexible long metallic plate by curving the long metallic plate. The metallic plate forming the bump foil 60 is a plate of stainless steel, such as SUS301 or SUS304. Accordingly, in this embodiment, the hardness of the bump foil 60 is equal to the hardness of the top foil 50. The hardness of the bump foil 60 is higher than the hardness of the bearing housing 40.

The main body 61 is formed by curving a part of the long metallic plate into a corrugated shape. According to this embodiment, the longer direction of the metallic plate forming the bump foil 60 corresponds to the circumferential direction of the bearing housing 40. The shorter direction of the metallic plate forming the bump foil 60 corresponds to the axial direction of the bearing housing 40. The stopper 62 is formed by bending one end of the metallic plate, which is an end of the metallic plate in the circumferential direction of the bearing housing 40, in the radially outward direction.

As illustrated in FIG. 3, the stopper 62 of the first bump foil 60a is inserted into the second groove 41b. The stopper 62 of the second bump foil 60b is inserted into the third groove 41c. The stopper 62 of the third bump foil 60c is inserted together with the fixed end 53 of the top foil 50 into the fourth groove 41d.

As illustrated in FIGS. 2 and 3, the thin plate member 70 has a cylindrical portion 71, a first protruding portion 72, and a second protruding portion 73. The cylindrical portion 71 of the thin plate member 70 has an incomplete cylindrical shape that has a circumferential cutout. According to this embodiment, the length of the cylindrical portion 71 of the thin plate member 70 is approximately equal to the length of the main body 61 of the bump foil 60 in the axial direction of the rotary shaft 14. The cylindrical portion 71 has a first end and a second end in the circumferential direction of the cylindrical portion 71. The first protruding portion 72 protrudes radially outward from the first end of the cylindrical portion 71. The second protruding portion 73 protrudes radially outward from the second end of the cylindrical portion 71. The first protruding portion 72 and the second protruding portion 73 are a part of the thin plate member 70.

The thin plate member 70 is formed of a flexible long metallic plate by curving the long metallic plate. The metallic plate forming the thin plate member 70 is a plate of stainless steel, such as SUS301 or SUS304. Accordingly, in this embodiment, the hardness of the thin plate member 70 is equal to the hardness of the bump foil 60.

The cylindrical portion 71 is formed by curving a part of the long metallic plate into a cylindrical shape. According to this embodiment, the longer direction of the metallic plate forming the thin plate member 70 corresponds to the circumferential direction of the cylindrical portion 71. The shorter direction of the metallic plate forming the thin plate member 70 corresponds to the axial direction of the cylindrical portion 71. The metallic plate forming the thin plate member 70 has opposite ends in the longer direction, and the first protruding portion 72 and the second protruding portion 73 are formed by bending the opposite ends of the metallic plate in the radially outward direction of the cylindrical portion 71.

As illustrated in FIG. 3, the thin plate member 70 is disposed between the bearing housing 40 and the bump foils 60. The axial direction of the cylindrical portion 71 of the thin plate member 70 corresponds to the axial direction of the rotary shaft 14. The cylindrical portion 71 of the thin plate member 70 extends in the circumferential direction of the rotary shaft 14. Accordingly, the thin plate member 70 extends in the circumferential direction of the rotary shaft 14. The outer peripheral surface of the thin plate member 70 is in contact with the inner peripheral surface 40a of the bearing housing 40. The inner peripheral surface 71a of the thin plate member 70 is in contact with the depressions 61b of the bump foils 60 and spaced from the projections 61a of the bump foils 60. Accordingly, a space S is formed between each projection 61a of the bump foils 60 and the bearing housing 40. According to this embodiment, the space S is formed between each projection 61a of the bump foils 60 and the inner peripheral surface 71a of the thin plate member 70. The foil bearing 17 is cooled by refrigerant flowing through the space S.

The first protruding portion 72 and the second protruding portion 73 protrude toward the bearing housing 40 from the circumferentially opposite ends of the cylindrical portion 71. The first protruding portion 72 is inserted together with the free end 52 of the top foil 50 into the first groove 41a. The second protruding portion 73 is inserted together with the fixed end 53 of the top foil 50 and the stopper 62 of the third bump foil 60c into the fourth groove 41d. The insertion of the first protruding portion 72 and the second protruding portion 73 into the first groove 41a and the fourth groove 41d regulates the movement of the thin plate member 70 in the circumferential direction of the rotary shaft 14 relative to the bearing housing 40. The first groove 41a and the fourth groove 41d serve as the regulation groove of the present disclosure that regulates the movement of the top foil 50 and the thin plate member 70 in the circumferential direction of the rotary shaft 14. The stopper 62 of the third bump foil 60c is located between the fixed end 53 of the top foil 50 and the second protruding portion 73 of the thin plate member 70 in the circumferential direction of the bearing housing 40.

As illustrated in FIGS. 2 and 3, the thin plate member 70 has an opening, which, in this embodiment, is formed of a through hole 74 that is opened on the inner peripheral surface 71a of the thin plate member 70. According to this embodiment, specifically, the thin plate member 70 has two through holes 74. The two through holes 74 are spaced from each other in the circumferential direction of the cylindrical portion 71. Specifically, the through holes 74 include a first through hole 74a and a second through hole 74b.

According to this embodiment, the through holes 74 are formed through the cylindrical portion 71 in the thickness direction of the cylindrical portion 71. That is, the through holes 74 are formed through the cylindrical portion 71 in the radial direction of the rotary shaft 14. The through holes 74 extend in the axial direction of the rotary shaft 14. The length of each through hole 74 in the axial direction of the rotary shaft 14 is longer than the length of the stopper 62 of the first bump foil 60a and the length of the stopper 62 of the second bump foil 60b in the axial direction of the rotary shaft 14.

FIG. 4 is a developed view of the thin plate member 70. In FIG. 4, the bending positions of the first protruding portion 72 and the second protruding portion 73 are indicated by broken lines. Accordingly, the inner portion of the thin plate member 70 defined by the pair of broken lines forms the cylindrical portion 71. The outer portions of the thin plate member 70 defined by the short sides of the thin plate member 70 and the broken lines form the first protruding portions 72 and the second protruding portions 73.

As illustrated in FIG. 4, the thin plate member 70 has pairs of first facing surfaces 741 and pairs of second facing surfaces 742. Each through hole 74 is defined by the pair of first facing surfaces 741 and the pair of second facing surfaces 742. The pair of first facing surfaces 741 face each other in the axial direction of the rotary shaft 14. The pair of second facing surfaces 742 face each other in the circumferential direction of the rotary shaft 14.

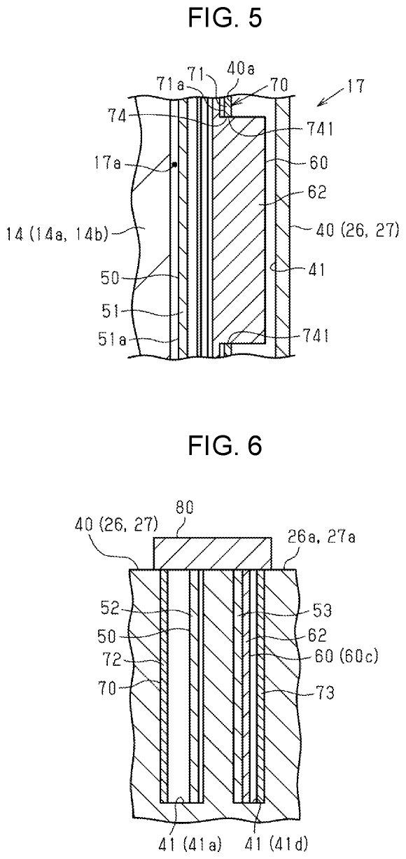

As illustrated in FIGS. 3 and 5, the stopper 62 of the first bump foil 60a is inserted into and engaged with the first through hole 74a. According to this embodiment, the first through hole 74a overlaps the second groove 41b of the bearing housing 40 in the radial direction of the rotary shaft 14. The second groove 41b serves as the overlap groove of the present disclosure that overlaps the first through hole 74a in the radial direction of the rotary shaft 14. According to this embodiment, a part of the first bump foil 60a is inserted into and engaged with the second groove 41b through the first through hole 74a. The stopper 62 of the first bump foil 60a is located between the first facing surfaces 741 that define the first through hole 74a in the axial direction of the rotary shaft 14. The stopper 62 of the first bump foil 60a is located between the second facing surfaces 742 that define the first through hole 74a in the circumferential direction of the rotary shaft 14.

The stopper 62 of the second bump foil 60b is inserted into and engaged with the second through hole 74b. According to this embodiment, the second through hole 74b overlaps the third groove 41c of the bearing housing 40 in the radial direction of the rotary shaft 14. The third groove 41c serves as the overlap groove of the present disclosure that overlaps the second through hole 74b in the radial direction of the rotary shaft 14. According to this embodiment, a part of the second bump foil 60b is inserted into and engaged with the third groove 41c through the second through hole 74b. The stopper 62 of the second bump foil 60b is located between the first facing surfaces 741 that define the second through hole 74b in the axial direction of the rotary shaft 14. The stopper 62 of the second bump foil 60b is located between the second facing surfaces 742 that define the second through hole 74b in the circumferential direction of the bearing housing 40.

As illustrated in FIG. 6, the regulator 80 is disposed on the first groove 41a and the fourth groove 41d and regulates the movement of the top foil 50 and the thin plate member 70 in the axial direction of the rotary shaft 14. According to this embodiment, the regulator 80 is disposed on the end surface 26a of the boss 26 and the end surface 27a of the boss 27 that serve as one end surface of the bearing housing 40 in the axial direction of the bearing housing 40. The regulator 80 is fixed to the boss 26 and the boss 27 by a bolt (not illustrated). The regulator 80 is disposed on the first groove 41a and the fourth groove 41d such that the regulator 80 covers the opening of the first groove 41a and the opening of the fourth groove 41d on the end surface 26a of the boss 26 and the end surface 27a of the boss 27.

The free end 52 of the top foil 50 and the first protruding portion 72 of the thin plate member 70 are located between a surface of the bearing housing 40 defining the first groove 41a and the regulator 80 in the axial direction of the bearing housing 40. The fixed end 53 of the top foil 50, the stopper 62 of the third bump foil 60c, and the second protruding portion 73 of the thin plate member 70 are located between a surface of the bearing housing 40 defining the fourth groove 41d and the regulator 80 in the axial direction of the bearing housing 40.

Accordingly, the free end 52 comes into contact with the surface defining the first groove 41a or the regulator 80 when the top foil 50 moves in the axial direction of the rotary shaft 14. The fixed end 53 comes into contact with the surface defining the fourth groove 41d or the regulator 80. This regulates the movement of the top foil 50 in the axial direction of the rotary shaft 14 relative to the bearing housing 40. This therefore prevents the top foil 50 from falling out of the bearing housing 40.

The first protruding portion 72 comes into contact with the surface defining the first groove 41a or the regulator 80 when the thin plate member 70 moves in the axial direction of the rotary shaft 14. The second protruding portion 73 comes into contact with the surface defining the fourth groove 41d or the regulator 80. This regulates the movement of the thin plate member 70 in the axial direction of the rotary shaft 14 relative to the bearing housing 40. This therefore prevents the thin plate member 70 from falling out of the bearing housing 40. Therefore, the regulator 80 prevents the movement of the top foil 50 and the thin plate member 70 in the axial direction of the rotary shaft 14 relative to the bearing housing 40.

Furthermore, the stopper 62 comes into contact with the surface defining the fourth groove 41d or the regulator 80 when the third bump foil 60c moves in the axial direction of the rotary shaft 14. This regulates the movement of the third bump foil 60c in the axial direction of the rotary shaft 14 relative to the bearing housing 40. This therefore prevents the third bump foil 60c from falling out of the bearing housing 40. According to this embodiment, therefore, the regulator 80 prevents the movement of the third bump foil 60c in the axial direction of the rotary shaft 14 relative to the bearing housing 40.

The rotary shaft 14 rotates when the centrifugal compressor 10 is driven. The rotary shaft 14 rotates in a rotational direction R. When the rotary shaft 14 rotates, air is drawn into a gap between the outer peripheral surface of the rotary shaft 14 and the inner peripheral surface 51a of the foil cylindrical portion 51. The air flows through the gap between the rotary shaft 14 and the foil cylindrical portion 51 in the rotational direction R of the rotary shaft 14. The fourth groove 41d is defined by opposite surfaces. One of the opposite surfaces is located in front of the other of the opposite surfaces in the rotational direction R of the rotary shaft 14, and is closer to the first groove 41a than the other. The air flowing through the gap between the rotary shaft 14 and the foil cylindrical portion 51 presses the fixed end 53 of the top foil 50 against the one of the opposite surfaces. This regulates the movement of the fixed end 53 in the fourth groove 41d in the rotational direction R while the rotary shaft 14 is rotating.

When the rotational speed of the rotary shaft 14 reaches a predetermined rotational speed, the air, which has been drawn into the gap between the rotary shaft 14 and the foil cylindrical portion 51, forms a fluid film 17a. The dynamic pressure of the fluid film 17a allows the rotary shaft 14 to float off the top foil 50. The fluid film 17a allows the rotary shaft 14 to be supported by the fluid film 17a in the radial direction without being in contact with the top foil 50.

The fluid film 17a causes the foil cylindrical portion 51 of the top foil 50 to become elastically deformed and bulge in the radially outward direction of the rotary shaft 14. In this situation, the free end 52 of the top foil 50 moves in the first groove 41a in the rotational direction R. The width of the first groove 41a in the circumferential direction of the bearing housing 40 is determined such that the free end 52 does not come into contact with the surface defining the first groove 41a when the foil cylindrical portion 51 becomes elastically deformed. This does not regulate the movement of the free end 52 in the first groove 41a in the rotational direction R when the foil cylindrical portion 51 becomes elastically deformed. This therefore allows the elastic deformation of the foil cylindrical portion 51.

The elastic deformation of the foil cylindrical portion 51 causes the projections 61a of the bump foil 60 to be subjected to a load applied by the foil cylindrical portion 51. The load applied by the foil cylindrical portion 51 causes the projections 61a to become elastically deformed such that the projections 61a extend in the circumferential direction of the rotary shaft 14. This configuration allows the top foil 50 to be elastically supported by the main body 61 of the bump foil 60. The depressions 61b slide on the inner peripheral surface 71a of the thin plate member 70 along with the elastic deformation of the projections 61a.

### Operation of First Embodiment

The following will explain the operation according to the first embodiment. The thin plate member 70 has the first through hole 74a opened on the inner peripheral surface 71a of the thin plate member 70. The stopper 62 of the first bump foil 60a is inserted into and engaged with the first through hole 74a. That is, a part of the first bump foil 60a is inserted into and engaged with the first through hole 74a so that the movement of the first bump foil 60a is regulated in the circumferential direction and the axial direction of the rotary shaft 14 relative to the bearing housing 40.

Specifically, the stopper 62 comes into contact with the first facing surface 741 defining the first through hole 74a when the first bump foil 60a moves in the axial direction of the rotary shaft 14. This regulates the movement of the first bump foil 60a in the axial direction of the rotary shaft 14 relative to the bearing housing 40. This therefore prevents the first bump foil 60a from falling out of the bearing housing 40. Furthermore, the stopper 62 comes into contact with the second facing surface 742 defining the first through hole 74a when the first bump foil 60a moves in the circumferential direction of the rotary shaft 14. This regulates the movement of the first bump foil 60a in the circumferential direction of the rotary shaft 14 relative to the bearing housing 40.

The thin plate member 70 has the second through hole 74b opened on the inner peripheral surface 71a of the thin plate member 70. The stopper 62 of the second bump foil 60b is inserted into and engaged with the second through hole 74b. That is, a part of the second bump foil 60b is inserted into and engaged with the second through hole 74b so that the movement of the second bump foil 60b is regulated in the circumferential direction and the axial direction of the rotary shaft 14 relative to the bearing housing 40.

Specifically, the stopper 62 comes into contact with the first facing surface 741 defining the second through hole 74b when the second bump foil 60b moves in the axial direction of the rotary shaft 14. This regulates the movement of the second bump foil 60b in the axial direction of the rotary shaft 14 relative to the bearing housing 40. This therefore prevents the second bump foil 60b from falling out of the bearing housing 40. Furthermore, the stopper 62 comes into contact with the second facing surface 742 defining the second through hole 74b when the second bump foil 60b moves in the circumferential direction of the rotary shaft 14. This regulates the movement of the second bump foil 60b in the circumferential direction of the rotary shaft 14 relative to the bearing housing 40.

### Advantageous Effect of First Embodiment

The following will explain the advantageous effects according to the first embodiment.

(1-1) The bearing housing 40 has the first groove 41a and the fourth groove 41d into which a part of the top foil 50 and a part of the thin plate member 70 are inserted and which regulate the movement of the top foil 50 and the thin plate member 70 in the circumferential direction of the rotary shaft 14. The first groove 41a and the fourth groove 41d have the regulator 80 that regulates the movement of the top foil 50 and the thin plate member 70 in the axial direction of the rotary shaft 14.

The thin plate member 70 has the through holes 74 opened on the inner peripheral surface 71a of the thin plate member 70. A part of the corresponding bump foil 60 is inserted into and engaged with each through hole 74 so that the movement of the bump foil 60 is regulated in the circumferential direction and the axial direction of the rotary shaft 14 relative to the bearing housing 40. This prevents the bump foil 60 from falling out of the bearing housing 40. This configuration eliminates a need for a plurality of regulators arranged in the circumferential direction of the bearing housing 40 or a need for a groove which is formed in the bearing housing 40 and in which a ring-shaped regulator is fitted. This configuration therefore prevents the bump foil 60 from falling out of the bearing housing 40 without increasing the number of parts of the foil bearing 17 and increasing the size of the bearing housing 40.

(1-2) The thin plate member 70 has the first through hole 74a that is formed through the thin plate member 70 in the radial direction of the rotary shaft 14. The first through hole 74a serves as the opening of the present disclosure that is opened on the inner peripheral surface 71a of the thin plate member 70. The bearing housing 40 has the second groove 41b that overlaps the first through hole 74a of the thin plate member 70 in the radial direction of the rotary shaft 14. The stopper 62 of the first bump foil 60a is inserted into and engaged with the second groove 41b through the first through hole 74a so that the movement of the first bump foil 60a is regulated in the circumferential direction and the axial direction of the rotary shaft 14 relative to the bearing housing 40. According to this configuration, the stopper 62 is more unlikely to fall out of the opening, compared with a configuration in which the opening is formed of a recess recessed in the inner peripheral surface 71a of the thin plate member 70.

Similarly, the thin plate member 70 has the second through hole 74b that is formed through the thin plate member 70 in the radial direction of the rotary shaft 14. The second through hole 74b serves as the opening of the present disclosure that is opened on the inner peripheral surface 71a of the thin plate member 70. The bearing housing 40 has the third groove 41c that overlaps the second through hole 74b of the thin plate member 70 in the radial direction of the rotary shaft 14. The stopper 62 of the second bump foil 60b is inserted into and engaged with the third groove 41c through the second through hole 74b so that the movement of the second bump foil 60b is regulated in the circumferential direction and the axial direction of the rotary shaft 14 relative to the bearing housing 40. According to this configuration, the stopper 62 is more unlikely to fall out of the opening, compared with a configuration in which the opening is formed of a recess recessed in the inner peripheral surface 71a of the thin plate member 70.

(1-3) The hardness of the bearing housing 40 is lower than the hardness of the bump foil 60. Accordingly, if the thin plate member 70 is not disposed between the bearing housing 40 and the bump foil 60, the bump foil 60 slides on the bearing housing 40, which leads to wear of the bearing housing 40. According to the first embodiment, the thin plate member 70 is disposed between the bearing housing 40 and the bump foils 60. This configuration reduces wear of the bearing housing 40 caused by sliding of the bump foil 60 on the bearing housing 40. The hardness of the thin plate member 70 is equal to the hardness of the bump foil 60. Accordingly, the bump foil 60 and the thin plate member 70 are unlikely to become worn although the bump foil 60 slides on the thin plate member 70.

(1-4) According to the first embodiment, the single thin plate member 70 is disposed between the bearing housing 40 and the plurality of bump foils 60. This configuration reduces the number of parts of the foil bearing 17, compared with a configuration in which a plurality of thin plate member 70 is arranged between the bearing housing 40 and the bump foils 60 in the circumferential direction of the rotary shaft 14.

(1-5) According to the first embodiment, the boss 26 and the boss 27 each serving as the bearing housing 40 are disposed inside the coil ends 34a of the stator 31. Accordingly, if the boss 26 and the boss 27 are increased in size, the increased bosses 26, 27 may interfere with the coil ends 34a. Furthermore, even if the bosses 26, 27 do not interfere with the coil ends 34a, it is preferable to secure a clearance between the bosses 26, 27 and the coil ends 34a for a cooling flow passage and the like. According to the first embodiment, the presence of the through hole 74 of the thin plate member 70 prevents the bump foils 60 from falling out of the bearing housing 40 without increasing the size of the boss 26 and the size of the boss 27. This configuration therefore prevents the bosses 26, 27 from interfering with the coil ends 34a. Furthermore, this configuration easily secures the clearance between the bosses 26, 27 and the coil ends 34a.

### Second Embodiment

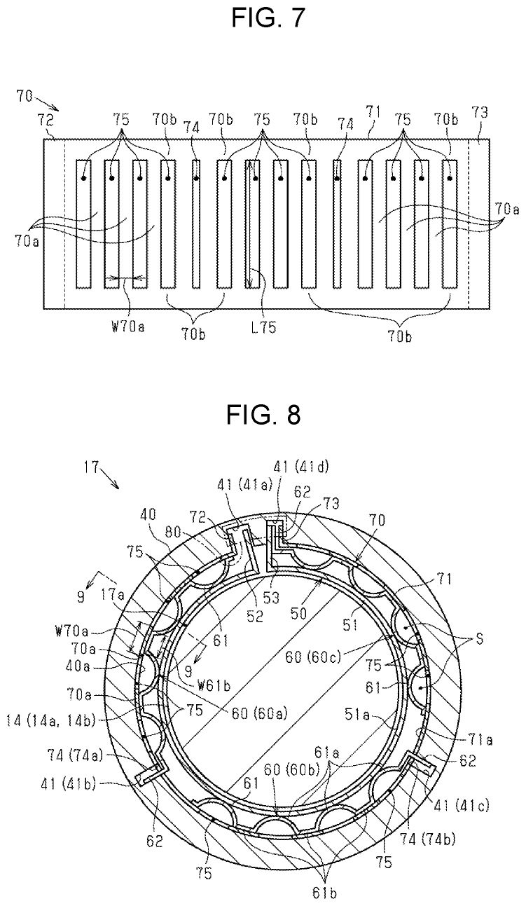

The following will describe a second embodiment of a foil bearing with reference to accompanying FIGS. 7 to 9. The same configuration as in the first embodiment is not elaborated here.

As illustrated in FIGS. 7 and 8, the thin plate member 70 has a plurality of refrigerant passages 75. The refrigerant passages 75 are formed through the cylindrical portion 71 in the radial direction of the rotary shaft 14. The refrigerant passages 75 extend in the axial direction of the rotary shaft 14. The refrigerant passages 75 are spaced from each other in the circumferential direction of the cylindrical portion 71. According to the second embodiment, all the refrigerant passages 75 have the same shape and the same size. The thin plate member 70 has a plurality of contact portions 70a. Each contact portion 70a is a portion of the thin plate member 70 between the adjacent refrigerant passages 75 in the circumferential direction of the rotary shaft 14. The thin plate member 70 further has two connecting portions 70b. The refrigerant passages 75 have one ends and the other ends in the axial direction of the rotary shaft 14. One of the connecting portions 70b is a portion of the thin plate member 70 extending across the one ends of the refrigerant passages 75, and the other of the connecting portions 70b is a portion of the thin plate member 70 extending across the other ends of the refrigerant passages 75. The refrigerant passages 75 are not opened at the opposite ends of the thin plate member 70 in the axial direction of the rotary shaft 14.

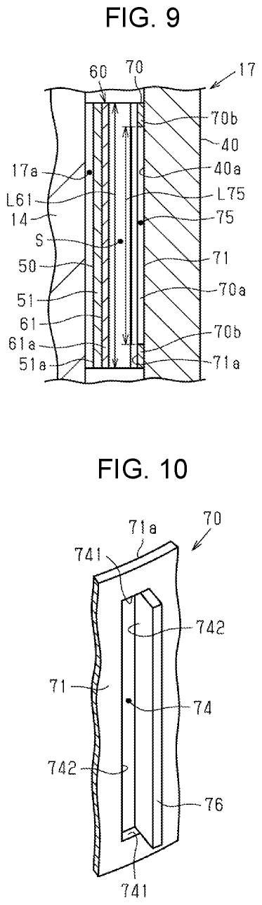

As illustrated in FIGS. 8 and 9, each refrigerant passage 75 of the thin plate member 70 and the corresponding projection 61a of the bump foil 60 are arranged in the radial direction of the rotary shaft 14. The thin plate member 70 is not disposed between the projection 61a and the bearing housing 40 in an area where the refrigerant passage 75 and the corresponding projection 61a are arranged in the radial direction of the rotary shaft 14. This increases the space S between the projection 61a and the bearing housing 40 by the thickness of the thin plate member 70. That is, the space S between the projection 61a and the bearing housing 40 is increased by the presence of the refrigerant passage 75. Refrigerant in the space S flows through the refrigerant passage 75 in the axial direction of the rotary shaft 14.

As illustrated in FIG. 8, the refrigerant passages 75 of the thin plate member 70 and the depressions 61b of the bump foils 60 are arranged in the circumferential direction of the rotary shaft 14. Each contact portion 70a of the thin plate member 70 and the corresponding depression 61b of the bump foils 60 are arranged in the radial direction of the rotary shaft 14. The contact portion 70a is in contact with the corresponding depression 61b. According to the second embodiment, a width W70a of the contact portion 70a in the circumferential direction of the rotary shaft 14 is larger than a width W61b of the depression 61b in the circumferential direction of the rotary shaft 14. The width W70a of the contact portion 70a in the circumferential direction of the rotary shaft 14 is the width of a portion of the thin plate member 70 between the adjacent refrigerant passages 75 in the circumferential direction of the rotary shaft 14. Accordingly, the width W70a of a portion of the thin plate member 70 between the adjacent refrigerant passages 75 in the circumferential direction of the rotary shaft 14 is larger than the width W61b of the depression 61b in the circumferential direction of the rotary shaft 14. The contact portion 70a is in contact with the whole of the corresponding depression 61b in the circumferential direction of the rotary shaft 14.

As illustrated in FIG. 9, a length L75 of the refrigerant passage 75 in the axial direction of the rotary shaft 14 is shorter than a length L61 of the main body 61 of the bump foil 60 in the axial direction of the rotary shaft 14. The opposite ends of the projection 61a in the axial direction of the rotary shaft 14 and the one and the other of the connecting portions 70b of the thin plate member 70 are arranged in the radial direction of the rotary shaft 14, respectively. The opposite ends of the space S in the axial direction of the rotary shaft 14 are respectively located on the opposite sides of the refrigerant passage 75 in the axial direction of the rotary shaft 14. At the opposite ends of the space S in the axial direction of the rotary shaft 14, the connecting portions 70b of the thin plate member 70 are disposed between the projection 61a and the bearing housing 40. Accordingly, the space S is reduced at the opposite ends of the space S in the axial direction of the rotary shaft 14.

### Operation and Advantageous Effects of Second Embodiment

The second embodiment exhibits following advantageous effects in addition to the effects of the first embodiment mentioned in (1-1) to (1-5).

(2-1) Each bump foil 60 has projections 61a in contact with the top foil 50 and the depressions 61b in contact with the thin plate member 70. The projections 61a and the depressions 61b are alternately arranged in the circumferential direction of the rotary shaft 14. The foil bearing 17 is cooled by the refrigerant flowing through the space S between the projection 61a of the bump foil 60 and the bearing housing 40.

According to the second embodiment, the thin plate member 70 has the refrigerant passages 75 that are formed through the thin plate member 70 in the radial direction of the rotary shaft 14. Refrigerant in the space S flows through the refrigerant passage 75 in the axial direction of the rotary shaft 14. Each projection 61a of the bump foil 60 and the corresponding refrigerant passage 75 of the thin plate member 70 are arranged in the radial direction of the rotary shaft 14. The thin plate member 70 is not disposed between the projection 61a and the bearing housing 40 in an area where the refrigerant passage 75 and the corresponding projection 61a are arranged in the radial direction of the rotary shaft 14. This increases the space S by the thickness of the thin plate member 70. That is, the space S is increased by the presence of the refrigerant passage 75. This increases the cooling effect on the foil bearing 17.

Instead of the refrigerant passage 75 of the thin plate member 70, the inner peripheral surface 40a of the bearing housing 40 may have a recess to increase the space S. However, providing the refrigerant passage 75 of the thin plate member 70 is less costly in manufacturing than providing the recess of the inner peripheral surface 40a of the bearing housing 40.

(2-2) The width W70a of a portion of the thin plate member 70 between the adjacent refrigerant passages 75 in the circumferential direction of the rotary shaft 14 is larger than the width W61b of the depression 61b in the circumferential direction of the rotary shaft 14. In this configuration, the thin plate member 70 is disposed between the depression 61b and the bearing housing 40. Accordingly, the depression 61b is unlikely to come in contact with the bearing housing 40 even if the bump foil 60 moves in the circumferential direction of the rotary shaft 14. This configuration further reduces wear of the bearing housing 40 caused by sliding of the bump foil 60 on the bearing housing 40.

(2-3) The refrigerant passages 75 have one ends and the other ends in the axial direction of the rotary shaft 14. The thin plate member 70 has the connecting portions 70b. One of the connecting portions 70b extends across the one ends of the refrigerant passages 75, and the other of the connecting portions 70b extends across the other ends of the refrigerant passages 75. In this configuration, the refrigerant passages 75 are not opened at the opposite ends of the thin plate member 70 in the axial direction of the rotary shaft 14. This configuration, for example, increases the durability of the thin plate member 70, compared with a case where the refrigerant passage 75 is formed of a slit that is opened at one end of the thin plate member 70 in the axial direction of the rotary shaft 14. Furthermore, this configuration suppresses deformation of the thin plate member 70, thereby facilitating handling of the thin plate member 70 in the assembling of the foil bearing 17.

(2-4) The length L75 of the refrigerant passage 75 in the axial direction of the rotary shaft 14 is shorter than the length L61 of the main body 61 of the bump foil 60 in the axial direction of the rotary shaft 14. The opposite ends of the projection 61a in the axial direction of the rotary shaft 14 and the one and the other of the connecting portions 70b of the thin plate member 70 are arranged in the radial direction of the rotary shaft 14, respectively.

On the opposite sides of the refrigerant passage 75 in the axial direction of the rotary shaft 14, the connecting portions 70b of the thin plate member 70 are disposed between the projection 61a and the bearing housing 40. Accordingly, the space S is reduced on the opposite sides of the refrigerant passage 75 in the axial direction of the rotary shaft 14. This allows the flow of the refrigerant in the space S to change on the opposite sides of the refrigerant passage 75 in the axial direction of the rotary shaft 14, thereby further increasing the cooling effect on the foil bearing 17.

### Modification Example

The aforementioned embodiments may be modified as described below. The embodiments may be combined with the following modification examples within technically consistent range.

According to the embodiments, a part of the bump foil 60 is inserted into and engaged with the opening, which is the through hole 74 formed through the thin plate member 70 in the radial direction of the rotary shaft 14. However, the opening of the present disclosure is not limited to the through hole 74. The opening may be formed of a recess that is formed in the inner peripheral surface 71a of the thin plate member 70 as long as the recess is opened on the inner peripheral surface 71a of the thin plate member 70.

The thin plate member 70 may be formed as described below.

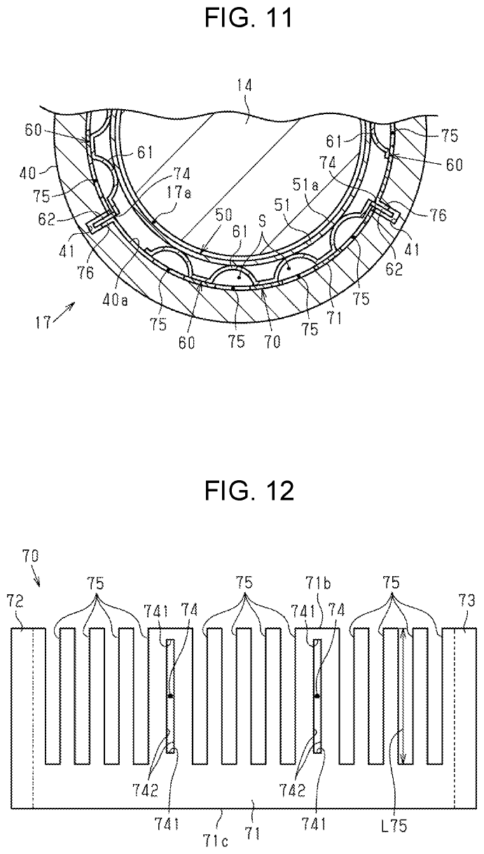

As illustrated in FIGS. 10 and 11, the thin plate member 70 has a plurality of third protruding portions 76 that each serve as the protruding portion of the present disclosure. Each of the third protruding portions 76 defines the corresponding through hole 74. The third protruding portion 76 protrudes toward the bearing housing 40. Specifically, the third protruding portion 76 forms one of the pair of the second facing surfaces 742.

As illustrated in FIG. 11, the third protruding portion 76 is inserted into and engaged with the overlap groove of the present disclosure, which, in the embodiments, is the groove 41 into which the stopper 62 of the bump foil 60 is inserted. Accordingly, the movement of the thin plate member 70 is regulated in the circumferential direction of the rotary shaft 14 relative to the bearing housing 40.

In addition to the insertion of the first protruding portion 72 and the second protruding portion 73 into the first groove 41a and the fourth groove 41d, according to this configuration, the third protruding portion 76 of the thin plate member 70 is inserted into and engaged with the corresponding groove 41. Accordingly, the movement of the thin plate member 70 is further regulated in the circumferential direction of the rotary shaft 14 relative to the bearing housing 40.

This configuration is more effective if the bump foils 60 and the thin plate member 70 are arranged such that the projection 61a and the corresponding refrigerant passage 75 are arranged in the radial direction of the rotary shaft 14 while the depression 61b and the refrigerant passage 75 are arranged in the circumferential direction of the rotary shaft 14, like the second embodiment. Regulating the movement of the thin plate member 70 in the circumferential direction relative to the bearing housing 40 suppresses misalignment between the bump foils 60 and the thin plate member 70 in the circumferential direction of the rotary shaft 14. This facilitates maintenance of the arrangement of the projection 61a and the refrigerant passage 75 in the radial direction of the rotary shaft 14, thereby facilitating maintenance of the space S increased by the presence of the refrigerant passage 75.

The third protruding portion 76 may form the first facing surface 741 as long as the third protruding portion 76 defines the through hole 74.

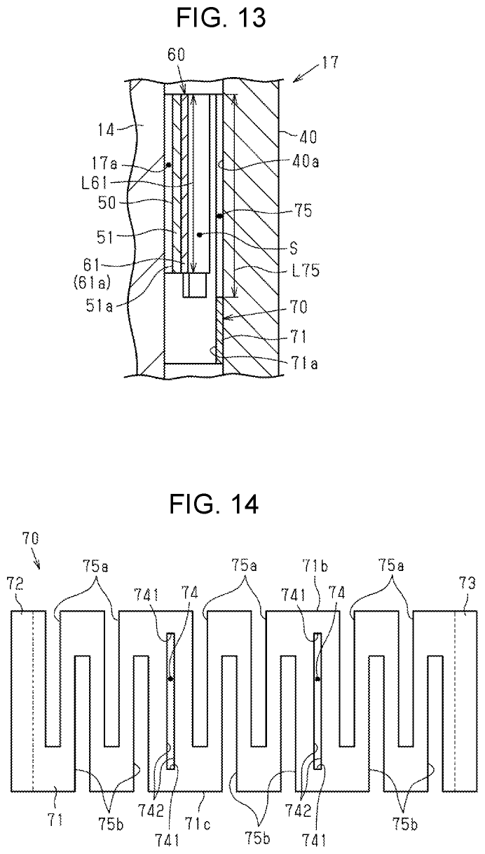

As illustrated in FIGS. 12 and 13, the refrigerant passage 75 may be formed of a slit that is opened on a first end surface 71b of one end of the cylindrical portion 71 in the axial direction. The length L75 of the refrigerant passage 75 in the axial direction of the rotary shaft 14 is longer than the length L61 of the main body 61 of the bump foil 60 in the axial direction of the rotary shaft 14. The whole of the projection 61a in the axial direction of the rotary shaft 14 and the refrigerant passage 75 are arranged in the radial direction of the rotary shaft 14.

For example, if a part of the projection 61a in the axial direction of the rotary shaft 14 and the thin plate member 70 are arranged in the radial direction of the rotary shaft 14, the space S is reduced in an area where the projection 61a and the thin plate member 70 are arranged. However, according to the configuration of the modification example previously described, the whole of the projection 61a in the axial direction of the rotary shaft 14 and the refrigerant passage 75 are arranged in the radial direction of the rotary shaft 14. This configuration does not cause reduction of the space S. This configuration therefore facilitates the flow of the refrigerant in the space S.

As illustrated in FIG. 14, the thin plate member 70 may have a plurality of slits each serving as the opening of the present disclosure. The plurality of slits may include a plurality of first refrigerant passages 75a and a plurality of second refrigerant passages 75b. The first refrigerant passages 75a may be opened on the first end surface 71b of the one end of the cylindrical portion 71 in the axial direction of the cylindrical portion 71, and the second refrigerant passages 75b may be opened on a second end surface 71c of the other end of the cylindrical portion 71 in the axial direction of the cylindrical portion 71. The first refrigerant passages 75a and the second refrigerant passages 75b are alternately arranged in the circumferential direction of the cylindrical portion 71.

When the thin plate member 70 has the plurality of refrigerant passages 75, the plurality of refrigerant passages 75 may include a hole-shaped refrigerant passage 75 as described in the second embodiment and a slit-shaped refrigerant passage 75 as illustrated in FIGS. 12 to 14.

In the first embodiment, the length of the stopper 62 of the first bump foil 60a may be equal to the length of the main body 61 in the axial direction of the rotary shaft 14. The length of the stopper 62 of the second bump foil 60b may be equal to the length of the main body 61 in the axial direction of the rotary shaft 14. In this configuration, the length of the bump foil 60 in the axial direction of the rotary shaft 14 is shorter than the length of the through hole 74 in the axial direction of the rotary shaft 14.

In the second embodiment, the length L75 of the refrigerant passage 75 in the axial direction of the rotary shaft 14 may be equal to or longer than the length L61 of the main body 61 of the bump foil 60 in the axial direction of the rotary shaft 14. The whole of the projection 61a in the axial direction of the rotary shaft 14 and the refrigerant passage 75 may be arranged in the radial direction of the rotary shaft 14.

The width of the refrigerant passage 75 in the circumferential direction of the rotary shaft 14 may be modified as necessary. For example, the width of the refrigerant passage 75 in the circumferential direction of the rotary shaft 14 may be increased in a part of the foil bearing 17 in the circumferential direction of the foil bearing 17 where a temperature is likely to increase, and may be decreased in a part of the foil bearing 17 in the circumferential direction of the foil bearing 17 where a temperature is unlikely to increase.

The number of the refrigerant passages 75 may be modified as necessary. For example, the number of the refrigerant passages 75 may be increased in a part of the foil bearing 17 in the circumferential direction of the foil bearing 17 where a temperature is likely to increase, and may be decreased in a part of the foil bearing 17 in the circumferential direction of the foil bearing 17 where a temperature is unlikely to increase.

The bearing housing 40 may be formed of a member, instead of the bosses 26, 27. The bearing housing 40 may be a member that is formed separately from the bosses 26, 27.

Each of the grooves 41 of the bearing housing 40 may be opened on the opposite end surfaces of the bearing housing 40 in the axial direction of the bearing housing 40. In this configuration, two regulators 80 are disposed on the opposite end surfaces of the bearing housing 40 in the axial direction of the bearing housing 40, respectively.

In the embodiments, the foil bearing 17 includes the three bump foils 60, but the number of the bump foils 60 is not limited thereto. The foil bearing 17 may include two bump foils 60, and may include four or more bump foils 60.

In the embodiments, the foil bearing 17 includes the single thin plate member 70. However, the foil bearing 17 may include two or more thin plate members 70.

The hardness of the thin plate member 70 may be lower than the hardness of the bump foil 60. In this case, the inner peripheral surface 71a of the thin plate member 70 may have a coating so as to reduce wear due to sliding of the bump foil 60 on the thin plate member 70.

The material of the thin plate member 70 may be different from the material of the bump foil 60. As long as the hardness of the thin plate member 70 is substantially equal to the hardness of the bump foil 60, wear of the bump foil 60 and the thin plate member 70, which is caused by sliding of the bump foil 60 on the thin plate member 70 is suppressed. That is, as long as the hardness of the thin plate member 70 is substantially equal to the hardness of the bump foil 60, the material of the thin plate member 70 may be different from the material of the bump foil 60.

As long as the regulator 80 regulates the movement of the top foil 50 and the thin plate member 70 in the axial direction of the rotary shaft 14 relative to the bearing housing 40, the method for fixing the regulator 80 to the bearing housing 40 may be modified as necessary. For example, the regulator 80 may be fitted into the first groove 41a and the fourth groove 41d by pressing so as to be fixed to the bearing housing 40.

According to the embodiments, the foil bearing 17 is applied to the centrifugal compressor 10, but the present disclosure is not limited thereto.

### Additional Statement

The following will describe technical ideas of the embodiments and the modification examples.

[1] A foil bearing comprising: a bearing housing having a cylindrical shape and through which a rotary shaft is inserted; a top foil disposed between the rotary shaft and the bearing housing, and having a bearing surface that faces the rotary shaft and extends in a circumferential direction of the rotary shaft; a plurality of bump foils disposed outward of the top foil and configured to extend to elastically support the top foil; and a thin plate member disposed between the bump foils and the bearing housing and extending in the circumferential direction, and the bearing housing having a regulation groove into which a part of the top foil and a part of the thin plate member are inserted and which regulates movement of the top foil and the thin plate member in the circumferential direction, wherein the foil bearing includes a regulator that is disposed on the regulation groove and regulates the movement of the top foil and the thin plate member in an axial direction of the rotary shaft, the thin plate member has an opening that is opened on an inner peripheral surface of the thin plate member, and a part of the bump foils is inserted into and engaged with the opening so that movement of the bump foils is regulated in the circumferential direction and the axial direction relative to the bearing housing.

[2] The foil bearing according to [1], wherein the opening is formed of a through hole that is formed through the thin plate member in a radial direction of the rotary shaft, the bearing housing has an overlap groove that overlaps the through hole in the radial direction, and a part of the bump foils is inserted into and engaged with the overlap groove through the through hole so that the movement of the bump foils is regulated in the circumferential direction and the axial direction relative to the bearing housing.

[3] The foil bearing according to [2], wherein the thin plate member has a protruding portion that defines the through hole and protrudes toward the bearing housing, and the protruding portion is inserted into and engaged with the overlap groove so that the movement of the thin plate member is regulated in the circumferential direction relative to the bearing housing.

[4] The foil bearing according to any one of [1] to [3], wherein the bump foils have a projection in contact with the top foil and a depression in contact with the thin plate member, the projection and the depression being arranged in the circumferential direction, the thin plate member has a plurality of refrigerant passages which is formed through the thin plate member in a radial direction of the rotary shaft and through which refrigerant flows in the axial direction, and the projection and the corresponding one of the refrigerant passages are arranged in the radial direction, and the depression and the refrigerant passage are arranged in the circumferential direction.

[5] The foil bearing according to [4], wherein a width of a portion of the thin plate member between the adjacent refrigerant passages in the circumferential direction is larger than a width of the depression in the circumferential direction.

[6] The foil bearing according to [4] or [5], wherein the refrigerant passages have one ends and the other ends in the axial direction, the thin plate member has connecting portions, and one of the connecting portions extends across the one ends of the refrigerant passages, and the other of the connection portions extends across the other ends of the refrigerant passages.

[7] The foil bearing according to [6], wherein a length of each of the refrigerant passages in the axial direction is shorter than a length of each of the bump foils in the axial direction, and opposite ends of the projection in the axial direction and the connecting portions are arranged in the radial direction, respectively.

[8] The foil bearing according to any one of [4] to [6], wherein a length of each of the refrigerant passages in the axial direction is longer than a length of each of the bump foils in the axial direction, and the whole of the projection in the axial direction and the corresponding one of the refrigerant passages are arranged in the radial direction.

What is claimed is:

1. A foil bearing comprising:
a bearing housing having a cylindrical shape and through which a rotary shaft is inserted;
a top foil disposed between the rotary shaft and the bearing housing, and having a bearing surface that faces the rotary shaft and extends in a circumferential direction of the rotary shaft;
a plurality of bump foils disposed outward of the top foil and configured to extend to elastically support the top foil; and
a thin plate member disposed between the bump foils and the bearing housing and extending in the circumferential direction, and
the bearing housing having a regulation groove into which a part of the top foil and a part of the thin plate member are inserted and which regulates movement of the top foil and the thin plate member in the circumferential direction, wherein
the foil bearing includes a regulator that is disposed on the regulation groove and regulates the movement of the top foil and the thin plate member in an axial direction of the rotary shaft,
the thin plate member has an opening that is opened on an inner peripheral surface of the thin plate member, and
a part of the bump foils is inserted into and engaged with the opening so that movement of the bump foils is regulated in the circumferential direction and the axial direction relative to the bearing housing.

2. The foil bearing according to claim 1, wherein
the opening is formed of a through hole that is formed through the thin plate member in a radial direction of the rotary shaft,
the bearing housing has an overlap groove that overlaps the through hole in the radial direction, and
the part of the bump foils is inserted into and engaged with the overlap groove through the through hole so that the movement of the bump foils is regulated in the circumferential direction and the axial direction relative to the bearing housing.

3. The foil bearing according to claim 2, wherein
the thin plate member has a protruding portion that defines the through hole and protrudes toward the bearing housing, and
the protruding portion is inserted into and engaged with the overlap groove so that the movement of the thin plate member is regulated in the circumferential direction relative to the bearing housing.

4. The foil bearing according to claim 1, wherein
the bump foils have a projection in contact with the top foil and a depression in contact with the thin plate member, the projection and the depression being arranged in the circumferential direction,
the thin plate member has a plurality of refrigerant passages which is formed through the thin plate member in a radial direction of the rotary shaft and through which refrigerant flows in the axial direction, and
the projection and the corresponding one of the refrigerant passages are arranged in the radial direction, and the depression and the refrigerant passage are arranged in the circumferential direction.

5. The foil bearing according to claim 4, wherein
a width of a portion of the thin plate member between the adjacent refrigerant passages in the circumferential direction is larger than a width of the depression in the circumferential direction.

6. The foil bearing according to claim 4, wherein
the refrigerant passages have one ends and the other ends in the axial direction,
the thin plate member has connecting portions, and
one of the connecting portions extends across the one ends of the refrigerant passages, and the other of the connection portions extends across the other ends of the refrigerant passages.

7. The foil bearing according to claim 6, wherein
a length of each of the refrigerant passages in the axial direction is shorter than a length of each of the bump foils in the axial direction, and
opposite ends of the projection in the axial direction and the connecting portions are arranged in the radial direction, respectively.

8. The foil bearing according to claim 4, wherein
a length of each of the refrigerant passages in the axial direction is longer than a length of each of the bump foils in the axial direction, and
the whole of the projection in the axial direction and the corresponding one of the refrigerant passages are arranged in the radial direction.
